(19) United States
(12) Patent Application Publication
(10) Pub. No.: US 2013/0179526 A1
(43) Pub. Date: Jul. 11, 2013

(54) INFORMATION PROCESSING METHOD, INFORMATION PROCESSING APPARATUS, AND CONTROL METHOD AND CONTROL PROGRAM THEREOF

(71) Applicant: Akihisa Kurashima, Tokyo (JP)

(72) Inventor: Akihisa Kurashima, Tokyo (JP)

(73) Assignee: NEC CORPORATION, Minato-ku, Tokyo (JP)

(21) Appl. No.: 13/876,552

(22) PCT Filed: Aug. 26, 2011
(86) PCT No.: PCT/JP2011/004755

§ 371 Date: Mar. 28, 2013

(30) Foreign Application Priority Data
Sep. 30, 2010 (JP) 2010-223052

(51) Int. Cl. H04L 29/06

(52) U.S. Cl. CPC H04L 63/1466
USPC 709/206

(57) ABSTRACT

An information processing apparatus includes a transfer unit that accesses a mail server in response to a mail browsing request from a user terminal, and reads mail data in the mail server from the mail server so as to be transferred to the user terminal, a transmission unit that transmits a notification mail for notifying the user terminal of a predetermined event to the mail server, and a deletion unit that accesses the mail server in response to a mail deletion request from the user terminal, and deletes mail data in the mail server, wherein deletion of the notification mail by the deletion unit is restricted.

### TECHNICAL FIELD

The present invention relates to a technique for controlling access to a mail server.

### BACKGROUND ART

As disclosed in Patent Document 1, a remote access server which controls access to a mail server from a portable terminal is known.

### RELATED DOCUMENT

### Patent Document

[Patent Document 1] Japanese Laid-open patent publication NO. 2001-312465

### DISCLOSURE OF THE INVENTION

However, in the related art, there is no means for preventing a malicious user from accessing a mail server from an information terminal via a remote access server, and, in the worst case scenario, the malicious user may read a mail without the authorized receiver ever becoming aware.

An object of the present invention is to provide a technique for solving the above-described problem.

In order to achieve the above-described object, an information processing apparatus related to the present invention includes a transfer unit that accesses a mail server in response to a mail browsing request from a user terminal, and reads mail data in the mail server from the mail server so as to be transferred to the user terminal; a transmission unit that transmits a notification mail for notifying the user terminal of a predetermined event to the mail server; and a deletion unit that accesses the mail server in response to a mail deletion request from the user terminal, and deletes mail data in the mail server, wherein deletion of the notification mail by the deletion unit is restricted.

In order to achieve the above-described object, an information processing method related to the present invention includes a transfer step of accessing a mail server in response to a mail browsing request from a user terminal, and reading mail data in the mail server from the mail server so as to be transferred to the user terminal; a transmission step of transmitting a notification mail for notifying the user terminal of a predetermined event to the mail server; a deletion step of accessing the mail server in response to a mail deletion request from the user terminal, and deleting mail data in the mail server; and a restriction step of restricting deletion of the notification mail.

In order to achieve the above-described object, in a method of controlling an information processing apparatus related to the present invention including a transfer unit that accesses a mail server in response to a mail browsing request from a user terminal, and reads mail data in the mail server from the mail server so as to be transferred to the user terminal; a transmission unit that transmits a notification mail for notifying the user terminal of a predetermined event to the mail server; and a deletion unit that accesses the mail server in response to a mail deletion request from the user terminal, and deletes mail data in the mail server, deletion of the notification mail by the deletion unit is restricted.

In order to achieve the above-described object, in a program for controlling an information processing apparatus related to the present invention including a transfer unit that accesses a mail server in response to a mail browsing request from a user terminal, and reads mail data in the mail server from the mail server so as to be transferred to the user terminal; a transmission unit that transmits a notification mail for notifying the user terminal of a predetermined event to the mail server; and a deletion unit that accesses the mail server in response to a mail deletion request from the user terminal, and deletes mail data in the mail server, the program causes a computer to execute a step of restricting deletion of the notification mail by the deletion unit.

According to the present invention, it is possible to reliably send a notification mail from an apparatus which controls access to a mail server, to an authorized user.

### BRIEF DESCRIPTION OF THE DRAWINGS

The above-described object, and other objects, features and advantages will become apparent from the preferable embodiments described below and the following accompanying drawings.

FIG. 1 is a block diagram illustrating a configuration of an information processing apparatus according to a first embodiment of the present invention.

FIG. 2 is a block diagram illustrating a configuration of an information processing system related to a premise technique of a second embodiment of the present invention.

FIG. 3 is a block diagram illustrating a configuration of the information processing system according to the second embodiment of the present invention.

FIG. 4 is a block diagram illustrating a detailed configuration of a mail access server according to the second embodiment of the present invention.

FIG. 5 is a diagram illustrating contents of a user information storage unit according to the second embodiment of the present invention.

FIG. 6 is a diagram illustrating contents of the user information storage unit according to the second embodiment of the present invention.

FIG. 7 is a flowchart illustrating a flow of an operation of the mail access server according to the second embodiment of the present invention.

FIG. 8 is a flowchart illustrating a flow of an operation of the mail access server according to the second embodiment of the present invention.

### DESCRIPTION OF EMBODIMENTS

Hereinafter, the embodiments of the present invention will be described in detail in an exemplified manner with reference to the drawings. However, constituent elements described in the following embodiments are only an example, and are not intended to limit the technical scope of the present invention thereto.

### First Embodiment

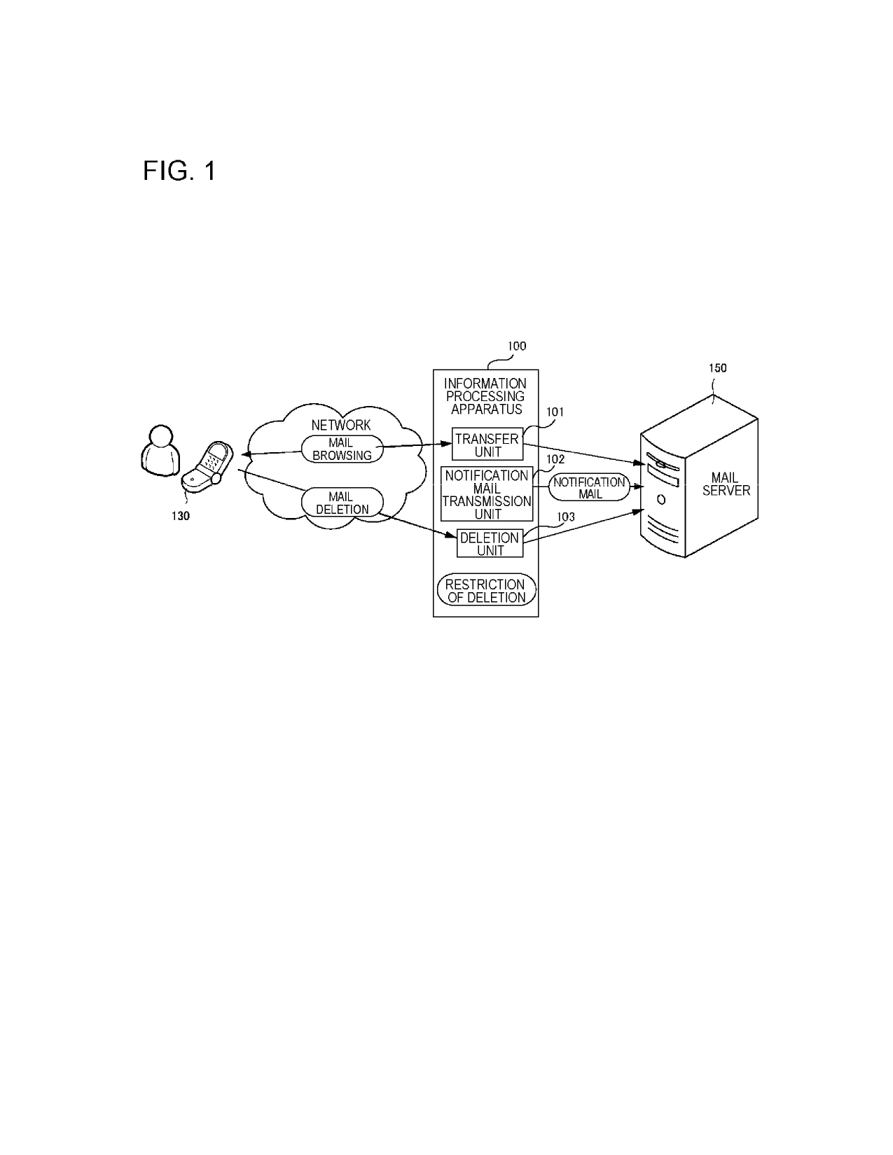

An information processing apparatus 100 according to the first embodiment of the present invention will be described with reference to FIG. 1. The information processing apparatus 100 is an apparatus which controls access to a mail server from a user terminal.

As shown in FIG. 1, the information processing apparatus 100 includes a transfer unit 101, a notification mail transmission unit 102, and a deletion unit 103. The transfer unit 101 accesses a mail server 150 in response to a mail browsing request from a user terminal 130, reads mail browsing data in the mail server 150, and transfers the data to the user terminal 130. The notification mail transmission unit 102 transmits a notification mail for notifying the user terminal 130 of a predetermined event to the mail server 150. In addition, the deletion unit 103 has a function of accessing the mail server 150 in response to a mail deletion request from the user terminal 130 and deletes mail data in the mail server 150.

In the present embodiment, the information processing apparatus 100 with this configuration restricts deletion of a notification mail by the deletion unit 103. Thereby, it is possible to reliably send a notification mail in the mail server to an authorized user.

### Second Embodiment

[Premise Technique]

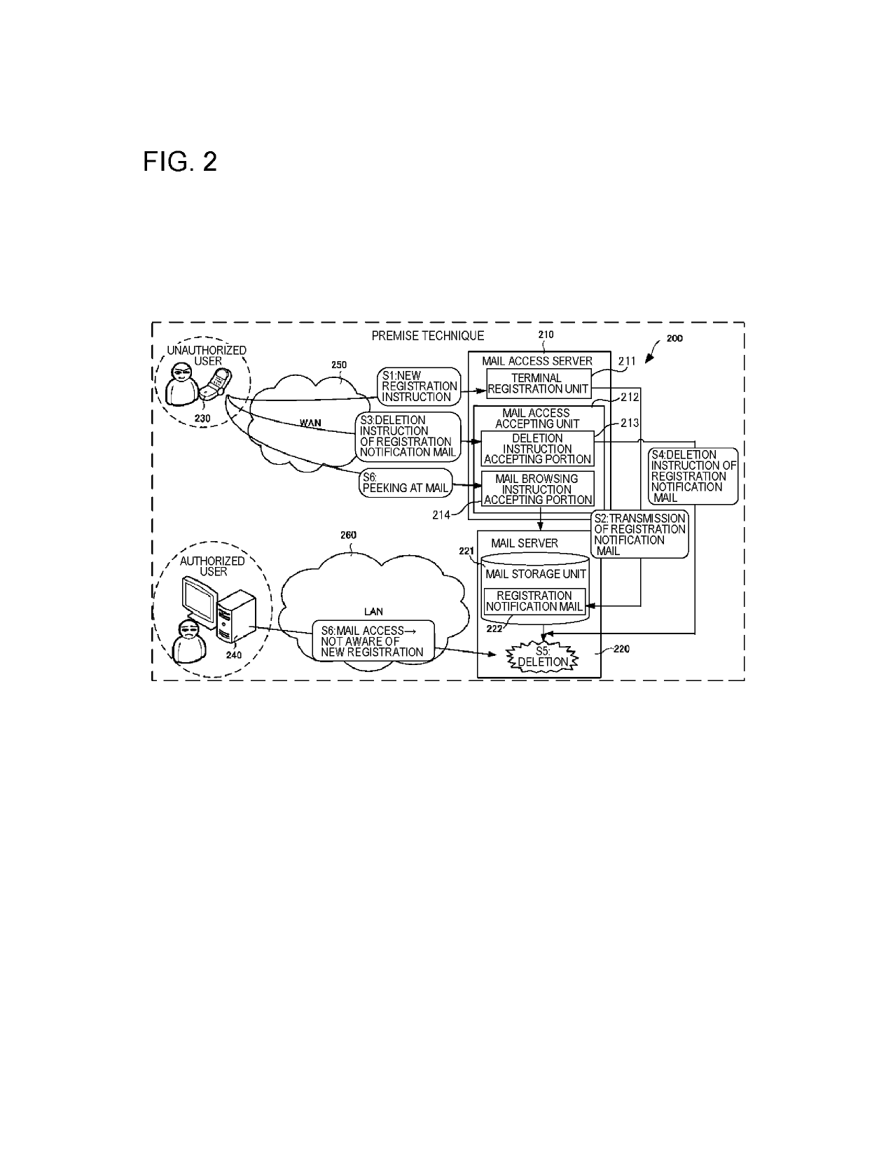

Before the second embodiment of the present invention is described, a premise technique thereof will be described with reference to FIG. 2. An information processing system 200 in FIG. 2 includes a mail access server 210, a mail server 220, and an information terminal 240 of an authorized user. In addition, the mail access server 210 includes a terminal registration unit 211 and a mail access accepting unit 212, and, the mail access accepting unit 212 includes a deletion instruction accepting portion 213, and a mail browsing instruction accepting portion 214. The mail access server 210 transfers mail held by the mail server 220 to users' terminals registered in the mail access server 210.

Here, a case where an unauthorized user registers an information terminal 230 of the unauthorized user as a terminal of an authorized user in the disguise of the authorized user is considered. This case is considered as a case or the like where, for example, a password of the user is necessary to register the terminal in the mail access server 210, and, thus the unauthorized user knows the password of the authorized user. When a new registration instruction is accepted from the information terminal 230 of the unauthorized user via a Wide Area Network (WAN) 250 (S1), the terminal registration unit 211 of the mail access server 210 generates a registration notification mail, and transmits the mail to the mail server 220 (S2). The mail server 220 preserves the received registration notification mail 222 in the mail storage unit 221.

The unauthorized user checks mail held by the mail server 220, using the information terminal 230. Then, the unauthorized user transmits a deletion instruction of the registration notification mail 222 to the mail access server 210 from the information terminal 230. When the deletion instruction is accepted from the information terminal 230 of the unauthorized user via the WAN (S3), the deletion instruction accepting portion 213 of the mail access server 210 transmits the deletion instruction of the registration notification mail 222 to the mail server 220 (S4). The mail server 220 deletes the registration notification mail 222 in the mail storage unit 221 in response to the deletion instruction (S5). Then, thereafter, the authorized user who accesses (S6) the mail server 220 from the information terminal 240 via a LAN 260 does not know that the unauthorized user has registered in the mail access server 210. Therefore, it is not possible to suppress the unauthorized user 230 from peeking at mails in the mail storage unit 221 via the mail browsing instruction accepting portion 214 of the mail access server 210 at all.

### Configuration of Present Embodiment

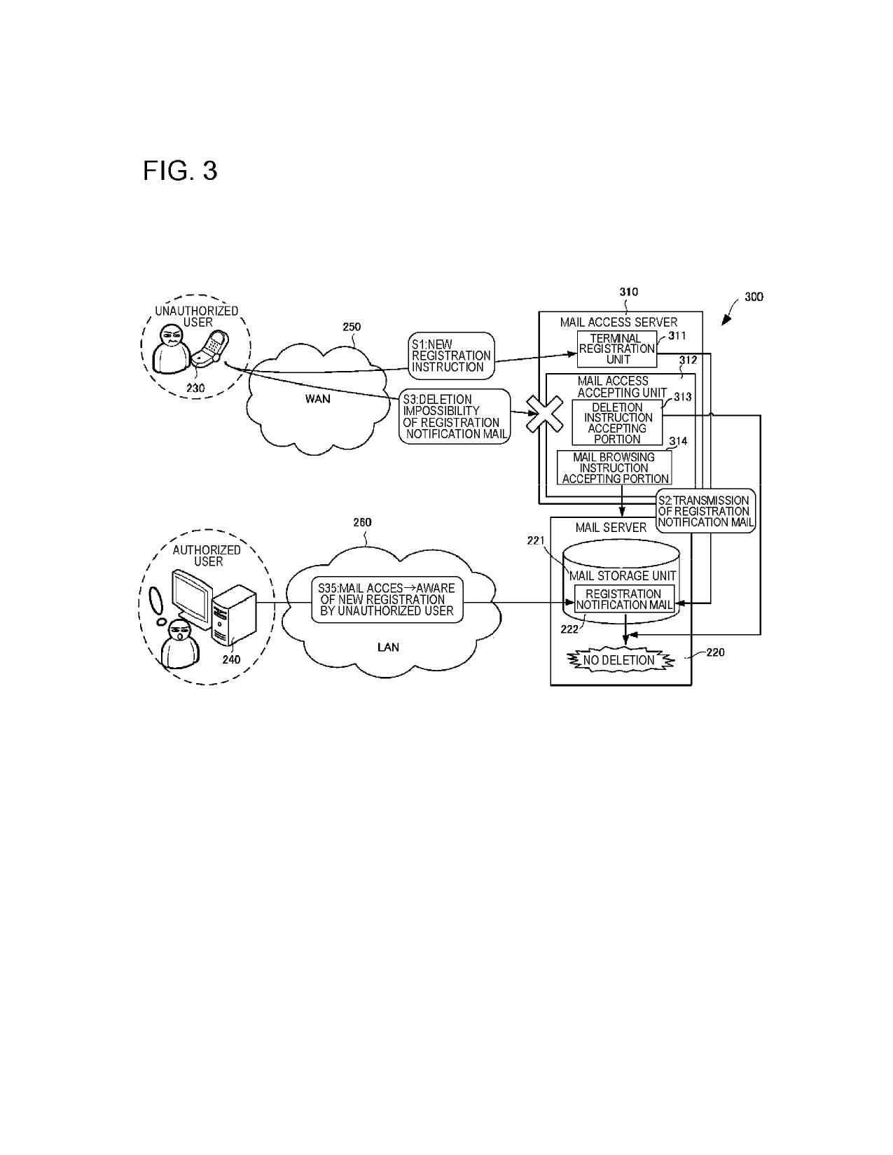

A functional configuration of the present embodiment will be described in detail with reference to FIG. 3. Unlike in the premise technique, a deletion instruction accepting portion 313 included in a mail access accepting unit 312 of a mail access server 310 which is an information processing apparatus is restricted so as not to accept a deletion request of a registration notification mail. Thereby, a deletion instruction of the registration notification mail 222 is not sent to the mail server 220, and, when a new registration is performed from the information terminal 230 of the unauthorized user, the authorized user is necessarily aware of the new registration (S35). In other words, there is an effect of reliably leaving traces of illegal access to the mail server and thus of the user becoming aware.

[Detailed Configuration of Mail Access Server]

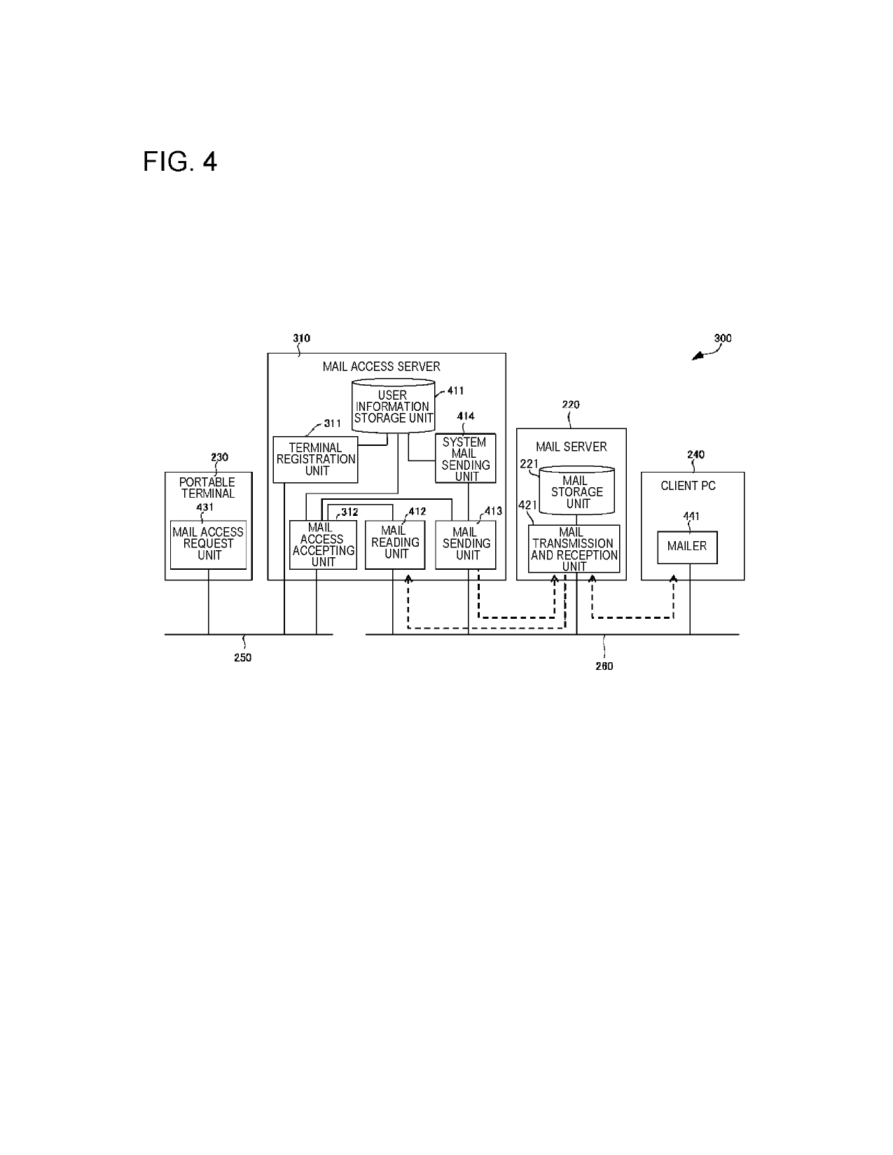

FIG. 4 is a diagram illustrating a more detailed configuration of the mail access server 310 of an information processing system 300 according to the present embodiment. As shown in FIG. 4, the information terminal 230 includes a mail access request unit 431. The mail access server 310 includes not only a terminal registration unit 311 and a mail access accepting unit 312 but also a user information storage unit 411, a mail reading unit 412, a mail sending unit 413, and a system mail sending unit 414. In addition, the mail server 220 includes not only the mail storage unit 221 but also a mail transmission and reception unit 421. Further, the information terminal 240 includes a mailer 441. With this configuration, the following respective operations are performed when a terminal is registered and a mail is referred to.

<Terminal Registration Operation>

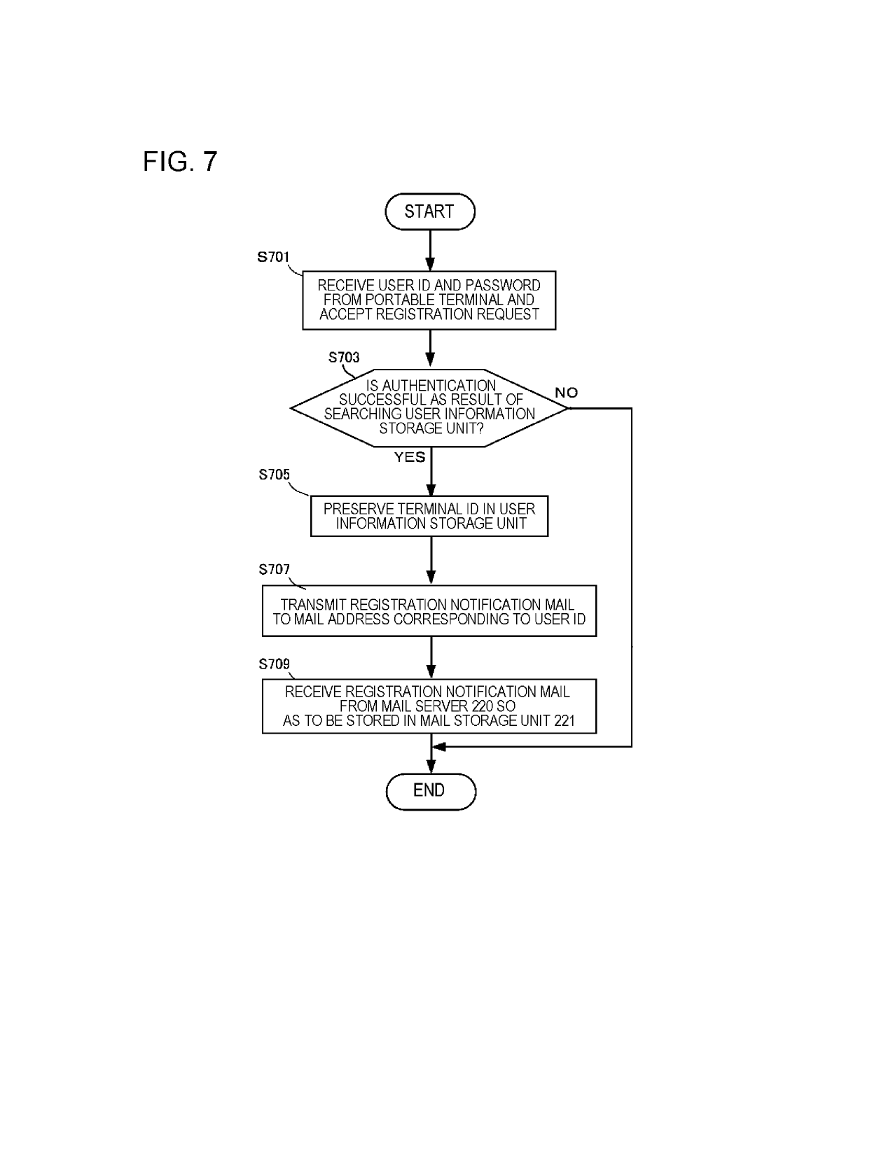

FIG. 7 is a flowchart illustrating a flow of the terminal registration operation. As shown in FIG. 7, in step S701, the terminal registration unit 311 receives a user ID and a password from the information terminal 230 and accepts a registration request (S701).

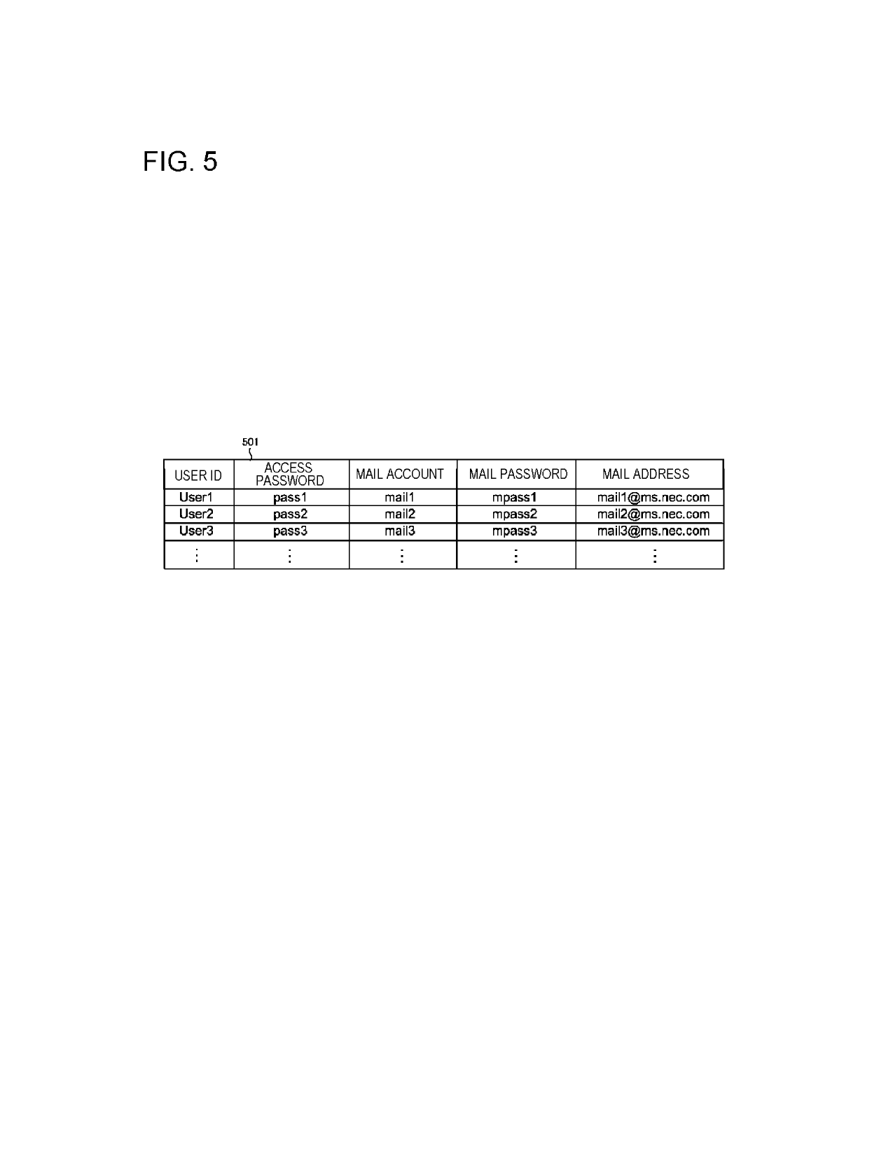

Next, in step S703, it is searched whether or not the user ID and the access password input from the information terminal 230 is stored as user information by referring to a table 501 of the user information storage unit 411 as shown in FIG. 5. Thereby, if the input user ID and access password are registered in the user information storage unit 411 as a result of the search, it is determined that authentication is successful (S703: Yes).

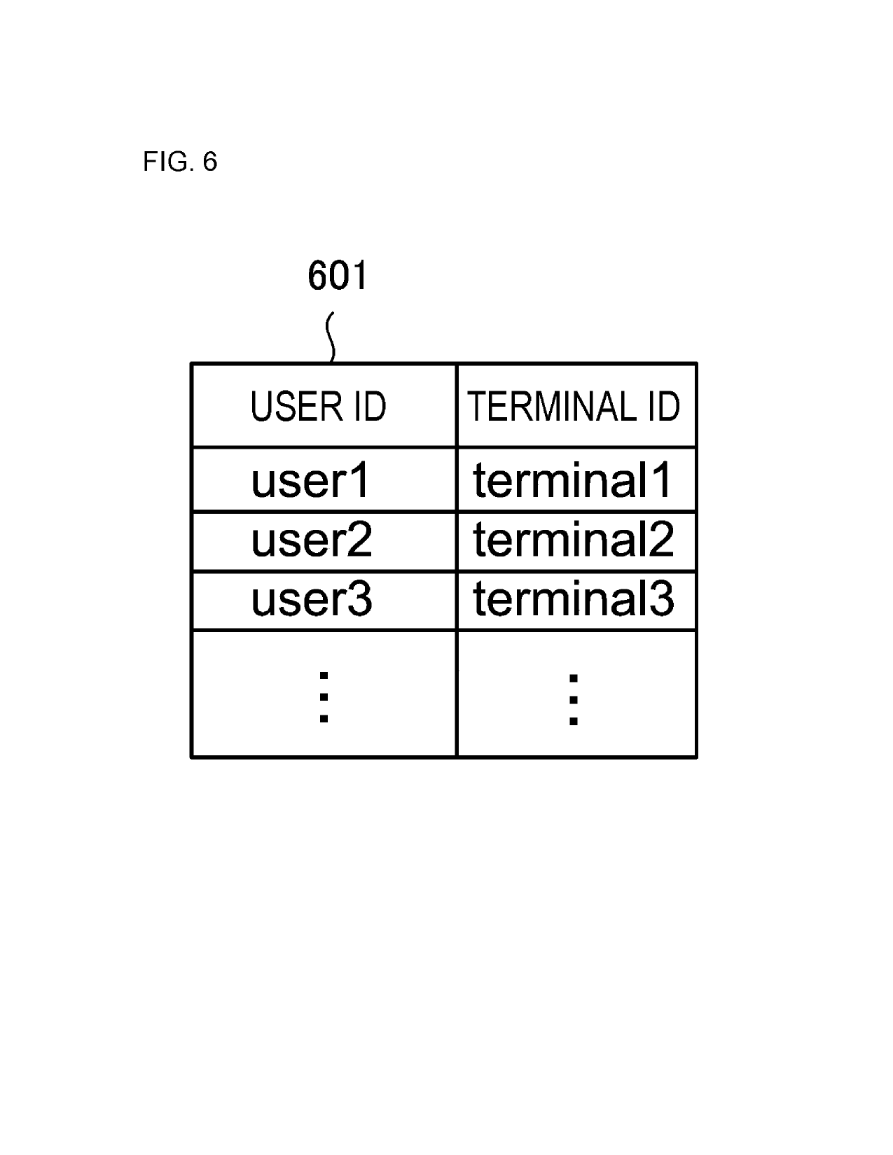

As shown in the table 501 of FIG. 5, the user information storage unit 411 preserves a user ID, an access password, a mail account, a mail password, and a mail address, in correlation with each other. If authentication is successful, a registration request is accepted, and, as shown in a table 601 of FIG. 6, the terminal ID of the information terminal 230 is preserved in the user information storage unit 411 so as to be correlated with the user ID (S705). Thereby, the registration for permitting access to the mail server is completed.

Next, a mail address corresponding to the user ID is specified, and information indicating that the terminal has been registered is transmitted to the mail address as a registration notification mail (S707). The registration notification mail includes device information of the registered terminal or information of User-Agent. Here, when the mail access server 310 sends the registration notification mail, the registration notification mail may be given “unique identification information for identifying the registration notification mail” and be sent. For example, a method of appending X-MAIL-TYPE: NOTIFY to a message header of the registration notification mail is considered. In addition, there may be a generation of a registration notification mail which includes dynamic information varying for each access, such as an IP address when the new terminal is registered or a host name inversely retrieved from the IP address using DNS.

When the mail sending unit 413 transmits the registration notification mail to the “mail address” of the user information registered in the table 501, the mail transmission and reception unit 421 of the mail server 220 receives the registration notification mail, and stores the mail to the mail storage unit 221 as mail of a corresponding mail account (S709).

The mail transmission and reception unit 421 reads the received mail from the mail storage unit 221 in response to a request of the mailer 441 of the information terminal 240 so as to be transmitted to the information terminal 240. For example, when the mail sending unit 413 transmits the registration notification mail to maill@ms.nec.com shown in the table 501 of FIG. 5, the mail is preserved in a mail storage region corresponding to the account called “maill” of the mail server 220. This mail can be referred to when accessed from “maill”.

<Operation of Referring to Mail>

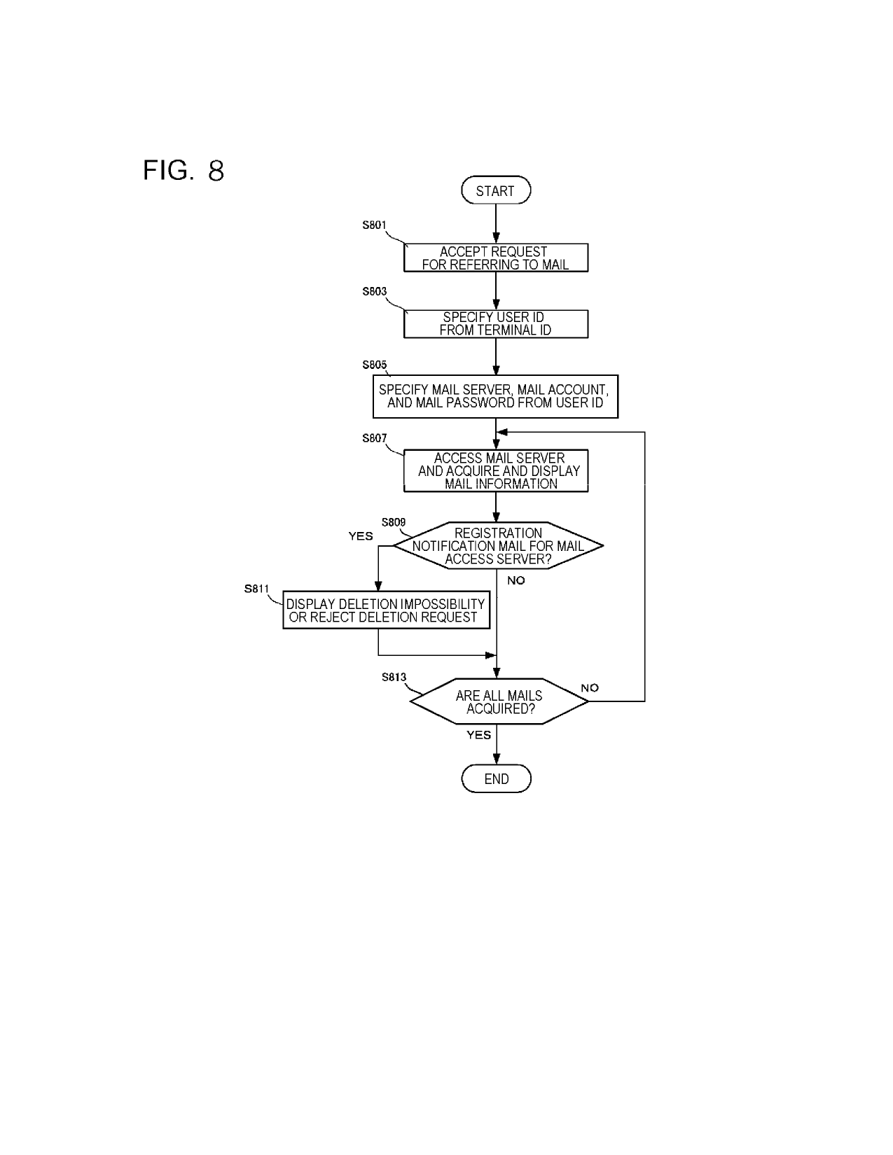

FIG. 8 is a flowchart illustrating a flow of an operation of referring to a mail. As shown in FIG. 8, in step S801, the mail access accepting unit 312 of the mail access server 310 accepts a request for referring to a mail from the mail access request unit 431 of the information terminal 230.

Next, in step S803, a user ID is specified by using a terminal ID included in the received request for referring to a mail and referring to the table 601 shown in FIG. 6.

In addition, in step S805, a mail server, a mail account, and a mail password are specified from the user ID. Next, in step S807, the mail server is accessed, and mail information is acquired from the mail server 220 and is displayed. Further, in step S809, it is determined whether or not the mail acquired from the mail server 220 is a mail transmitted from the mail access server 310. This can be determined by referring to, for example, an extension header of the mail, a transmission source address of the mail, or a title of the mail. Specifically, it is possible to determine whether or not a certain mail is a registration notification mail generated by the mail access server 310 by using a method such as X-MAIL-TYPE: NOTIFY being appended to the message header of the registration notification mail.

If it is determined that the mail is a registration notification mail transmitted from the mail access server 310 (S809: Yes), the flow proceeds to step S811 where display data is generated so as to perform display of deletion impossibility (non-display of a deletion button) or rejection of a deletion request (error display for selection of a deletion button). In addition, the flow proceeds to step 813 where it is determined whether or not all mails are acquired, and the processes in steps S807 to S811 are repeatedly performed until all the mails are acquired. When all the mails are acquired, the operation of referring to a mail finishes. In addition, there maybe settings in which a mail list is acquired and is displayed, and, if a registration notification mail transmitted from the mail access server 310 is designated, even an incoming deletion request is rejected.

### Other Embodiments

Although, in the first embodiment, deletion of a registration notification mail transmitted from the mail access server is restricted, the present invention is not limited thereto. The mail access server may transmit a record of access to the mail access server within a predetermined period as a notification mail. For example, deletion of a mail for transmitting a record of access to the mail access server of the previous day may be restricted.

As above, although the embodiments of the present invention have been described in detail, the present invention may be applied to a system including a plurality of apparatuses, or may be applied to a single apparatus.

In addition, the present invention may also be applied to a case where a control program for realizing the functions of the embodiments is supplied to a system or an apparatus directly or from a remote location. Therefore, in order to realize the functions of the present invention using a computer, a program installed in the computer, a medium storing the program therein, and a World Wide Web (WWW) server from which the program is downloaded are also included in the scope of the present invention.

This application is based upon and claims the benefit of priority from Japanese Patent Application No. 2010-223052, filed on Sep. 30, 2010, the entire contents all of which are incorporated herein by reference.

What is claimed is:

1. An information processing apparatus comprising:
a transfer unit that accesses a mail server in response to a mail browsing request from a user terminal, and reads mail data in the mail server from the mail server so as to be transferred to the user terminal;
a transmission unit that transmits a notification mail for notifying the user terminal of a predetermined event to the mail server; and
a deletion unit that accesses the mail server in response to a mail deletion request from the user terminal, and deletes mail data in the mail server,
wherein deletion of the notification mail by the deletion unit is restricted.

2. The information processing apparatus according to claim 1, wherein the deletion unit does not accept a request for deleting the notification mail from the user terminal.

3. The information processing apparatus according to claim 1, wherein the transmission unit transmits a registration notification mail for notifying a user that registration for permitting access to the mail server has been performed on a new terminal, to the mail server as the notification mail.

4. The information processing apparatus according to claim 3, wherein the registration notification mail includes information regarding the new terminal.

5. The information processing apparatus according to claim 4, wherein the information regarding the new terminal includes an IP address or a host name of the new terminal.

6. The information processing apparatus according to claim 1, wherein the transmission unit transmits a record of access to the information processing apparatus within a predetermined period to the mail server as the notification mail.

7. The information processing apparatus according to claim 1, wherein the transmission unit generates and transmits a notification mail in which identification information for indentifying a notification mail for notifying of the predetermined event is included in a mail header, a mail extension header, or a transmission source mail address, and
wherein the deletion unit determines whether or not a notification mail is a target of which deletion is restricted using the identification information.

8. The information processing apparatus according to claim 1, wherein the deletion unit determines whether or not a mail in the mail server is the notification mail on the basis of an extension header of the mail.

9. The information processing apparatus according to claim 1, wherein the deletion unit determines whether or not a mail in the mail server is the notification mail on the basis of a transmission source address of the mail.

10. The information processing apparatus according to claim 1, wherein the deletion unit determines whether or not a mail in the mail server is the notification mail on the basis of a title of the mail.

11. The information processing apparatus according to claim 1, wherein, when the transfer unit accesses the mail server in response to a mail browsing request from the user terminal, reads display data of a list of mails in the mail server from the mail server so as to be transmitted to the user terminal, the display data is generated so as to be unable to accept a deletion request of the notification mail.

12. An information processing method comprising:
a transfer step of accessing a mail server in response to a mail browsing request from a user terminal, and reading mail data in the mail server from the mail server so as to be transferred to the user terminal;
a transmission step of transmitting a notification mail for notifying the user terminal of a predetermined event to the mail server;
a deletion step of accessing the mail server in response to a mail deletion request from the user terminal, and deleting mail data in the mail server; and
a restriction step of restricting deletion of the notification mail.

13. A method of controlling an information processing apparatus including a transfer unit that accesses a mail server in response to a mail browsing request from a user terminal, and reads mail data in the mail server from the mail server so as to be transferred to the user terminal;
a transmission unit that transmits a notification mail for notifying the user terminal of a predetermined event to the mail server; and
a deletion unit that accesses the mail server in response to a mail deletion request from the user terminal, and deletes mail data in the mail server, wherein deletion of the notification mail by the deletion unit is restricted.

14. A computer program product comprising a non-transitory computer-readable recording medium storing instructions adapted to enable an information processing apparatus to implement:
a transfer unit that accesses a mail server in response to a mail browsing request from a user terminal, and reads mail data in the mail server from the mail server so as to be transferred to the user terminal;
a transmission unit that transmits a notification mail for notifying the user terminal of a predetermined event to the mail server; and
a deletion unit that accesses the mail server in response to a mail deletion request from the user terminal, and deletes mail data in the mail server;
wherein the information processing apparatus restricts deletion of the notification mail by the deletion unit.
